(19) United States
(12) Patent Application Publication
(10) Pub. No.: US 2026/0025557 A1
(43) Pub. Date: Jan. 22, 2026

(54) CONTENT DECISIONING IN ZERO-SLATE FOR STREAMING PALTFORMS

(71) Applicant: M/S. Amagi Media Labs Pvt. Ltd, Bangalore (IN)

(72) Inventors: Baskar Subramanian, Bangalore (IN); Sashidhar Bangar, Bengaluru (IN); Veeresh Ashok Sanagoudar, Layout (IN); Santosh Padmanabha Hegde, Uttara Kannada (IN); Srinidhi Srinivasmurthy, Mysuru (IN); Koyyalamudi Rama Subhrahmanyam, Bengaluru (IN)

(73) Assignee: M/S. Amagi Media Labs Pvt. Ltd, Bangalore (IN)

(21) Appl. No.: 19/177,527

(22) Filed: Apr. 12, 2025

Related U.S. Application Data
(60) Provisional application No. 63/633,486, filed on Apr. 12, 2024.

(51) Int. Cl. H04N 21/482; H04N 21/234; H04N 21/458

(52) U.S. Cl. CPC H04N 21/482; H04N 21/23424; H04N 21/458

(57) ABSTRACT

A system, method and computer program product for Content Decisioning within a Zero-Slate system for Linear TV having a configuration service, a default content ladder, a media prep module, a content fetching module, a content segmentation server and a load balancer to reduce ad-fatigue for viewers

### CROSS REFERENCE TO RELATED APPLICATIONS

This application claims the benefit of and priority on U.S. Provisional Patent Application No. 63/633,486 having a filing date of 12 Apr. 2024.

### FIELD OF THE INVENTION

This invention relates to a content decisioning system using an electronic programming guide (EPG) within a zero-slate system within Free Ad-supported Streaming TV (FAST).

### BRIEF DESCRIPTION

We propose a system, computer-implemented method and computer program product for Content Decisioning within a zero slate architecture for linear TV.

### BACKGROUND AND PRIOR ART

U.S. Pat. No. 8,495,675B1 titled “Method and System for Dynamically Inserting Content into Streaming Media” discloses a system and method for inserting targeted content, such as advertisements, into streaming media during playback using a manifest file containing both standard URIs for core media and meta URIs (muRIs) for dynamic content. These meta URIs direct playback devices to a decisioning server that selects personalized content based on real-time viewer data, such as demographics or location. This enables individualized experiences without regenerating manifests, supporting live and on-demand streams with scalable, context-aware advertising and interactive campaigns.

U.S. Pat. No. 11,917,217B2 titled “Managing Delivery of Digital Media Content” discloses a system for optimizing digital media delivery by using manifests that define both primary content and supplemental elements like ads or overlays. A media guidance system dynamically adjusts the playback experience based on user preferences, device types, and environmental factors. The system supports adaptive streaming, seamless content switching, and real-time decision-making for personalized ad insertion. It ensures compliance with advertiser rules while maintaining low latency and high playback quality, enabling customized, monetized content delivery across diverse platforms and use cases.

U.S. Pat. No. 10,979,775 titled ‘Seamless Switching from a Linear to a Personalized Video Stream’ discloses a method for seamless switching between linear and personalized video streams on a client device. The system allows the current linear video to finish before transitioning, ensuring uninterrupted viewing. Switching signals, embedded data, or content analysis determine transition timing. Users interact with the content through likes, skips, or volume changes, which inform future personalization. This hybrid model enhances user experience by blending passive viewing with personalized recommendations and supports both smart TVs and legacy set-top boxes, optimizing bandwidth and device compatibility.

U.S. Pat. No. 20,150,113570A1 titled ‘System and Method for Personalized TV’ discloses a system that personalizes TV content using metadata-driven segmentation and viewer preference analysis. By applying Bayesian and regression models, the system predicts and refines individual tastes. Users interact via likes, skips, or program selection, which updates their profiles. It supports multi-user environments, interactive content, and dynamic ad placement based on demographics. Closed captioning, EPG integration, and automated recording are also included. The system modernizes traditional television by introducing AI-driven content curation, allowing for a more relevant and responsive viewing experience across households and devices.

U.S. Pat. No. 11,051,061 titled ‘Publishing a Disparate Live Media Output Stream Using Pre-Encoded Media Assets’ discloses a system that simulates live broadcasts using pre-encoded VOD content. A network scheduler provides a program lineup, and the system builds a live output stream by inserting media segments into a manifest. This reduces infrastructure needs while supporting seamless content transitions and ad insertions. Content is validated and indexed to enable reliable playback. The method is ideal for scalable digital broadcasting and pop-up channels, enabling efficient delivery of live-like experiences without real-time encoding or centralized broadcast hardware.

### BRIEF DESCRIPTION OF THE DRAWINGS

FIG. 1 shows the overall system for Zero Slate linear TV.

FIG. 2 shows the Content Decisioning System and how it interacts with other major modules or components.

FIG. 2a shows the Content Decisioning Engine is more detail.

FIG. 3 shows the use case for Elastic Playout based on EPG.

FIG. 3a shows more details on the EPG-based playout.

FIG. 3b shows the standardized representation for the EPG.

FIG. 3c shows some examples of the EPG playout.

FIG. 4 shows the method for Content Decisioning.

### DETAILED DESCRIPTION OF PREFERRED EMBODIMENTS

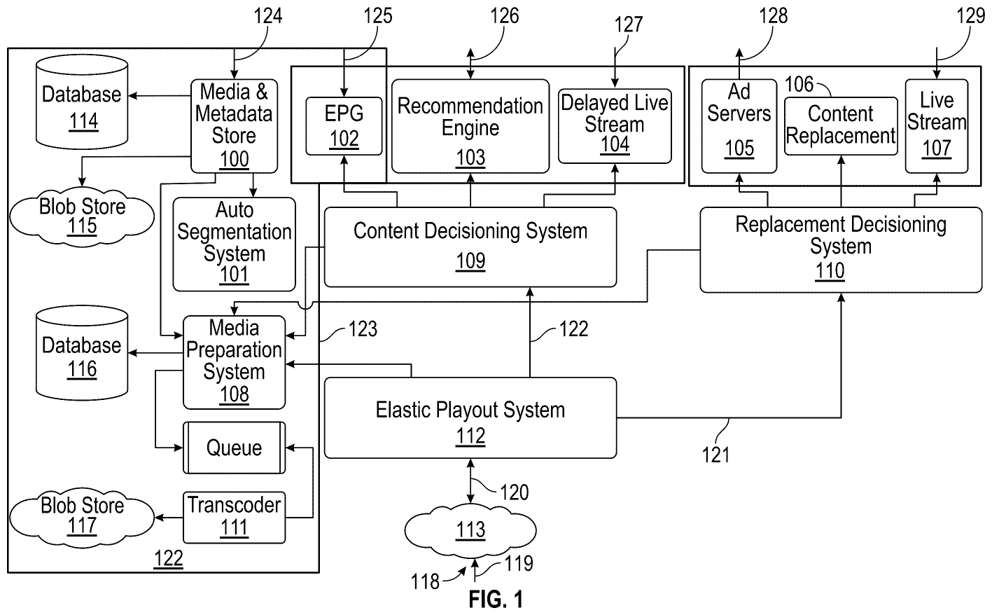

FIG. 1 shows the overall system for Zero Slate linear TV. There are four main sub-systems in the overall system including Media Preparation, Elastic Playout, Content Decisioning and Replacement Decisioning.

The Elastic Playout System (EPS) consults the Content Decisioning System (CDS) for the content to play to this user, passing user identifiers. CDS returns an array of content to stitch to the user, along with replacement markers indicating actions such as switching to a live event, stitching personalized ads, or replacing content. The Elastic Playout System further retrieves corresponding media segments from the Media Preparation System for the assets returned in STEP-2 and stitches them together to form a linear live stream. The assets returned in STEP-2 are stored as a segment buffer for that user, and preserved as long as the user is active. Once EPS detects that the user is inactive, this buffer is flushed.

While streaming the segments in STEP-3, when EPS encounters replacement markers, it requests the Replacement Decisioning System (RDS) by passing the marker type. RDS utilizes predefined rules and the marker type to determine replacement assets, which are then returned to be stitched into the live stream. Content is either inserted or replaced based on the marker type.

There are several components including the Ingest Media 100, EPG ingest 101, one or more recommendation engines 102, input live streams 103, an Ad network 104, and an input live stream 105. 101 interacts with a media and metadata store 107, which works with a database 106, a blob store 115, an auto-segmentation system 116 and a media preparation system 120 that interacts with the elastic layout system 124 and also with a database 119 and a queue 123. A transcoder 126 interacts with the queue 123 and a blob store 125. The EPG ingest 101 interacts with a EPG 108, which receives inputs from a content decisioning system 117. One or more recommendation engines 102 interact with one or more third-party or in-house recommendation engines 109, which also interact with the content decisioning system 117. An input live stream 103 interacts with a delayed live stream 110 which also interacts with the content decisioning system 117. There is an ad network 104 which interacts with one or more third-party ad servers 112, a content replacement block 113 and an input live stream 105 that interacts with a live stream 114. All these components 112, 113 and 114, interact with the replacement decisioning engine 118. One or more users 128 with Channel_IDs interact with a content distribution network (CDN) 127 which works with an elastic playout system 124 in fetching manifests from their origin 130

The Elastic Playout System 124 converts an array of media assets to a live stream works with the Media Preparation System 120 sending segmented content segments for media 121, the Content Decisioning System 117 where it gets program content, Channel_ID, user's details (IP, UserAgent, DeviceID, etc.) 122 and the Replacement Decisioning System 118 where it sends replacement content including Channel_ID, User's Details (IP, User Agent, Device ID, etc.) 131.

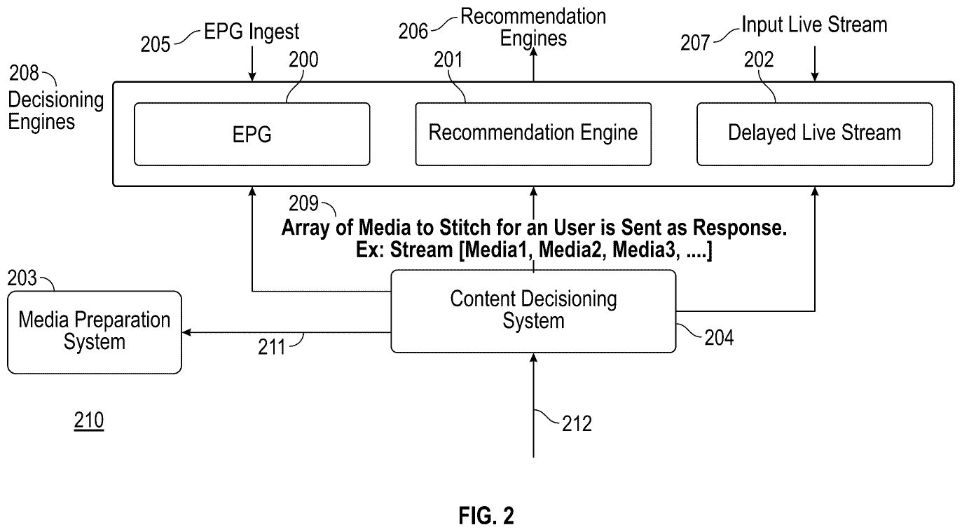

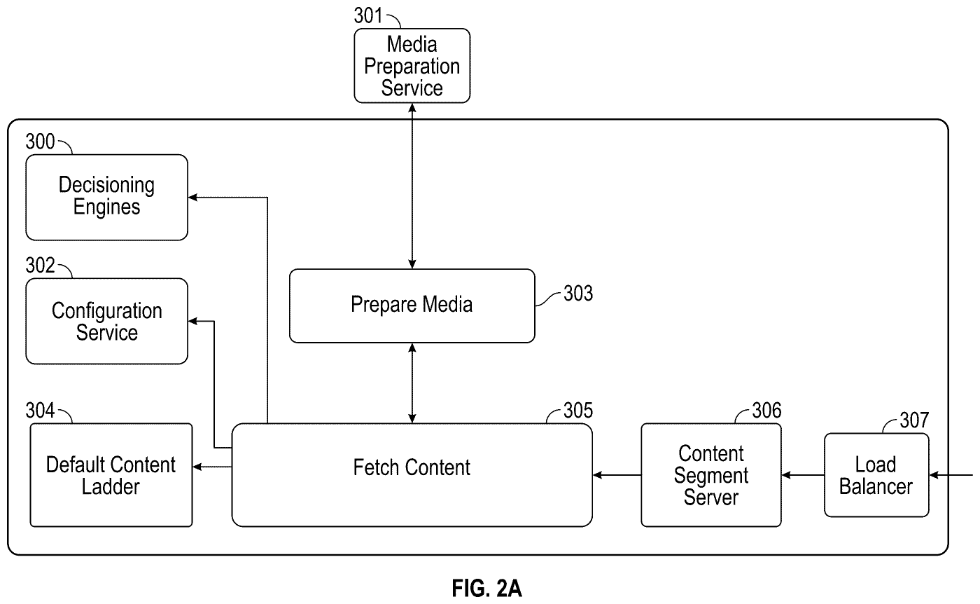

FIG. 2 shows the Content Decisioning System and how it interacts with other major modules or components. The components include decisioning engines 208 including an EPG 200 that receives an EPG Ingest 205, a recommendation engine 201 that interfaces with one or more external recommendation engines 206, a delayed live stream 202 that receives an input live stream 207, a content decisioning system 204 that sends an array of media to stitch for a user 209 and gets program content 212 and interfaces with a media preparation system 203 that enqueues assets for transcoding 211 and checks if media is already transcoded 210.

The EPG 200 parses EPG Responses into a Timeline of Assets. When requested it returns the media that is supposed to be played out at the current time. The recommendation engine 201, parses responses from external recommendation engines 206 into Internal Standardized Format. The delayed live stream 202 parses the Live HLS, Dash or Equivalent Sources and Bring them into Internal Standardized Format. The content decisioning system 204 is a one that returns an array of media assets. The Media preparation system (module) 203 is looked up to check if the assets are already transcoded and are ready to be served. If an asset is not transcoded, the media preparation system enqueues them for transcoding 210. For the assets which are not yet ready to serve, the fallback content is fetched from the config service. There is a ladder of content which have to be filled in that order in place of the missing asset. A channel can also have a policy to skip the missing assets and return rest of the assets in the order. The final array of segments to stream to the user is built. The order of the segments should match the order of the assets returned from the content decisioning system 204.

FIG. 2a shows the Content Decisioning System in more detail. There are one or more decisioning engines 300, which are interacting with a module to fetch content 305. The fetch content module 305 fetches content based on channel configuration. If there is Void in the EPG, or there is a Missing Asset, then default content is served using the channel's default content ladder 304. There is a Media Preparation Service 301 which works with a module to prepare media 303 and this is the module where ads and content assets are normalized to the channel's transcoding profile. There is a configuration service 302 which stores the mapping of channel to ad-tags and live URL configurations. There is also a content segment server 306 which serves an array of segments with trackers and other metadata. There is a load balancer 307 which redirects the user to content segment server.

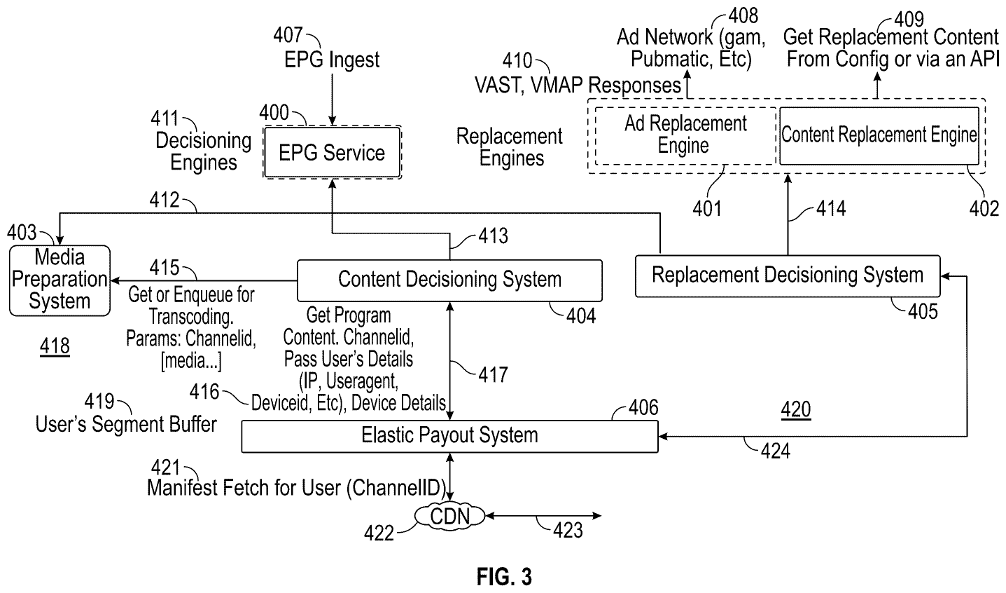

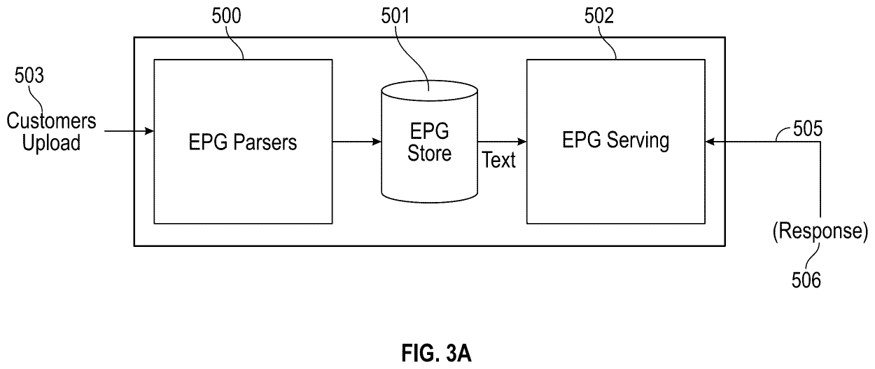

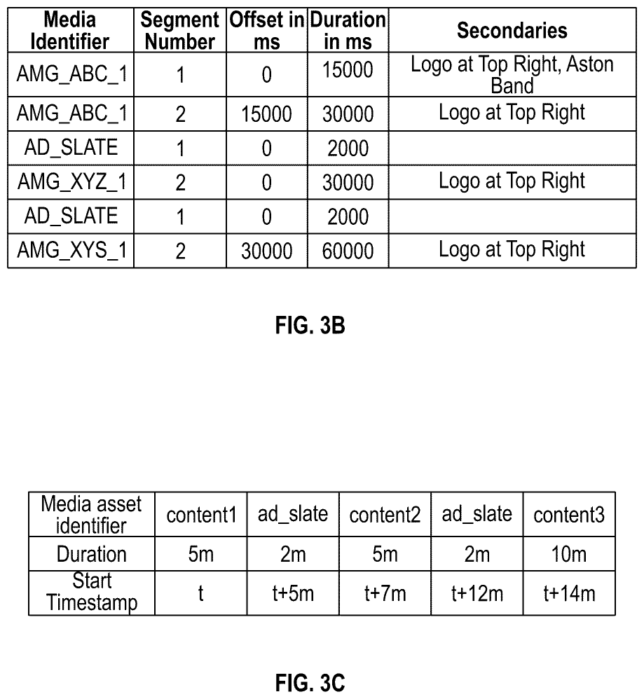

FIG. 3 shows the Content Decisioning Engine's use case for Elastic Playout based on EPG. The modules in this include an EPG Service 400, one or more replacement engines 413, a media preparation system 403, a content decisioning system 404, a replacement decisioning system 405, an elastic playout system 406 and a content distribution network (CDN) 425. We describe them in more detail below.

An Electronic Programming Guide Service 400 ingests one or more EPGs 407. This service 400 consumes the EPG schedules that are uploaded by the customer and stores it into a timestamp to asset mapping. When the content decisioning engine asks for the content to play, it uses the wall clock time that is sent as input to return the array of assets to play starting from the wall clock time. This service also takes as input an array 414 of media to stitch for a user is sent as response. Ex: stream [media1, media2, media3, . . . ].

The replacement engines 413 comprises of an ad replacement engine 401 and a content replacement engine 402. They obtain an Array of media to stitch for a user is sent as response. Ex: stream [media1, media2, media3, . . . ] 415 from the replacement decisioning system 405. The ad replacement engine 401 requests ad servers for personalized ads for a user. It passes user details, device details, EPG details, etc. to them to get personalized ads interacts with one or more ad networks (including GAM, PubMatic, etc.) 408 via VAST/VMAP responses 409. The content replacement engine 402 picks pre-defined content based on the channel's config or calls an api to get the replacement content. The response is standardized and returned back. 402 gets replacement content from configured values or via an API 410.

The media preparation engine 403 interacts with the replacement decisioning engine 405 by obtaining one or more return segments for a media if it is already transcoded media: [media_s1, media_s2, media_s3], for all the transcoding profiles of the channel 412. 403 further interacts with the content decisioning system 404 by obtaining for transcoding parameters including Channel_ID, [Media], etc. 416.

The content decisioning engine 404 exchanges an array of segments to stitch for a user is sent as response ex stream [media1_s1, media1_s2, media2_s1, media2_s2, media3_s1, media3_s2, media3_s3 . . . ] 419 from the Elastic Playout System (EPS) 406 and a ‘Get program content. Channel_ID, user's details (ip useragent, deviceid, etc), device detail-explain directionality please’ 418. The EPS 406 further exchanges a ‘get replacement content. Channel_ID, user's details (ip, useragent, deviceid, etc), device details, epg details, etc’ 421 and an Array of replacement segments to stitch for a user is sent as response ex stream [media1_s1, media1_s2, media2_s1, media2_s2, media3_s1, media3_s2, media3_s3 . . . ] 422. The EPS further contains a User's segment buffer user1: [media1_s1, media1_s2, media2_s1, media2_s2, media3_s1, ad1_s1, ad1_s2, media_s1, media_s2, media_s3] 420.

A content distribution network (CDN) 425 interacts with polls for manifest updates 424 and the EPS 406 and performs a manifest fetch for a user 423.

FIG. 3a shows more details on the EPG-based playout. One or more customers 503 upload EPG in multiple formats. One or more EPG parsers 500 brings them into a unified format where they convert the EPGs from various formats into a single format. These parsers interact with an EPG store 501 that enables every channel to get a twenty four hour playlist 504 daily. There is also an EPG serving subsystem 502 that returns an array of media 506. The input to this is customers uploading their customer or standard representations of the EPG and the content to stitch for a channel starting from time ‘T’ and for a duration of ‘x’ seconds 505, where ‘x’ can vary to create a personalized stream for every user.

FIG. 3b shows the standardized representation for the EPG. The Content Decisioning System would request EPG service for content to play for a channel at time T and for a duration of X seconds. The EPG Service returns an array of Media assets, ad slate if any and the corresponding Media metadata to the content decisioning system. Some of the metadata includes media identifier, segment number, offset, duration and secondaries.

FIG. 3c shows some examples of the EPG playout wherein a set of media asset identifiers with an associated duration and start timestamp can include content or advertisement slates.

The following paragraphs describe a user's journey in the system.
1. New user flow—
   User requests for a live manifest of a channel. This request reaches CDN which in-turn calls the origin-Elastic Playout System. At this point, EPS captures the user parameters like IP, UserAgent, Query Params, and Channel_ID.
   Elastic Playout System first checks in its database if a segment buffer exists for this user. If it does not find the segment buffer it calls the content decisioning engine passing user details, Channel_ID, start timeStamp, duration on content, etc. to it.
   Content decisioning engine checks the configured decision engine for the user's Channel_ID for the current time T and calls the corresponding decision engine. It passes the necessary parameters required for that decision engine. The decision engine for this use case is EPG service.
   EPG service checks the assets that is scheduled to be played at time T that is passed as input. It also returns subsequent T+X min worth of extra assets to play for the user.
   Content decisioning engine gets an array of assets to play from the EPG service. It then calls the Media Preparation Service for the segments for these assets.
   Media Preparation Service, checks in its database if the assets are already transcoded. If they are, it returns the segments for all the transcoding profiles that are configured for this channel. Media Preparation Service also returns the ad break points for the assets.
   Content decisioning gets the corresponding segments for the assets that are supposed to be played for a user. For the assets which are not transcoded yet, it sends out alternate content to play, these alternate content to play are configured at the channel level.
   Elastic Playout System gets the array of segments to stitch and the ad breakpoints for all the assets. It builds a segment buffer for the user. It then builds the manifest for this user and responds it back to the user via the CDN.
   Elastic Playout System keeps track of the liveliness of the user. If the user requests doesnt arrive at EPS any more for X continuous minutes, the user segment buffer is flushed.
2. Existing user flow
   User requests for a live manifest of a channel. This request reaches CDN which in turn calls the origin-Elastic Playout System.
   Elastic Playout System first checks in it database if a segment buffer exists for this user. When it finds the segment buffer, it moves the manifest window by a segment and updates the user state.
   It then builds the updated manifest and responds it back to the user.
3. Existing user flow with ad replacements
   User requests for a live manifest of a channel. This request reaches CDN which in turn calls the origin-Elastic Playout System.
   Elastic Playout System first checks in it database if a segment buffer exists for this user. When it finds the segment buffer, it checks if the next segment to publish to the user has a trigger marker. If true, a request is sent to Replacement Decisioning Engine. EPS system passes the EPG context, userID, Channel_ID, QueryParams, Ad break duration to Replacement Decisioning Engine.
   Replacement Decisioning Engine uses the trigger marker to determine the replacement engine type. For this use-case it calls the ad replacement engine. Ad replacement Engine uses the channel information to get the ad-tag. It replaces the macros in the ad-tag with user details and requests ad-servers.
   AdServers responds with the VAST or VMAP XML. This is parsed by the ad replacement engine and the ad assets in the XML, ad trackers are captured. It then builds internal standardized response and send it out.
   Replacement Decisioning Engine gets the ad assets and the trackers from ad replacement engine. It then gets the corresponding ad assets segments from media preparation system.
   When an ad is not transcoded yet in media preparation system it is skipped from stitching, but it is enqueued for transcoding so that it becomes usable in future.
   Replacement Decisioning Engine responds the ads back to Elastic Playout Engine.
   Elastic Playout System appends the ads to the user's segment buffer. It now stitches these ads in the manifest. There are beacons added in the manifest so that the ad quartiles can be tracked and reported back to ad-servers.
4. Extending the user's segment buffer
   User requests for a live manifest of a channel. This request reaches CDN which in turn calls the origin-Elastic Playout System.
   Elastic Playout System first checks in it database if a segment buffer exists for this user. When it finds the segment buffer of that user, it check if the buffer is about to be exhausted. At this point, fresh requests are made to Content Decisioning System passing the last segment's timestamp.
   Content Decisioning System then gets the content segments to play starting from this timestamp and returns the content assets.
   From this point onwards, it is the same as New user flow. These segments are appended to the user's segments buffer and the playout continues to happen.

### Example 1

These are sequences of events across the components.

Example EPG schedule to explain various workflows

| | Media asset identifier | | | | |
|---|---|---|---|---|---|
| | content 1 | ad_slate | content 2 | ad_slate | content 3 |
| Duration | 5 m | 2 m | 5 m | 2 m | 10 m |
| Start | t | t + 5 m | t + 7 m | t + 12 m | t + 14 m |
| Timestamp | | | | | |

New User flow using the above schedule for current time 100(epoch):
1. A new user “User 1” requests EPS for manifest.
2. EPS will not find the user buffer in the database, so it requests content decisioning system for content to playout for User 1 at time 100
3. Content decisioning system requests EPG service decision engine to get the content starting from time t
4. EPG services returns T to T+12 content. Response of EPG service [t: content1, t+5:ad_marker_of_2m, t+7: content2]
5. Content decisioning system gets the corresponding segments for these assets. Let us assume 1 m segments in this example. Response from media preparation service.

```
    {
      content1: {
        “Profile_1080”: [content1_s1, content1_s2, content1_s3,
  content1_s4, content1_s5],
        “Profile_720”: [content1_s1, content1_s2, content1_s3,
  content1_s4, content1_s5],
},
      content2: {
        “Profile_1080”: [content1_s1, content1_s2, content1_s3,
  content1_s4, content1_s5],
        “Profile_720”: [content1_s1, content1_s2, content1_s3,
  content1_s4, content1_s5],
},
  }
```

6. EPS builds the user's segments buffer like the following:

User1: [
100: content1_s1,
101: content1_s2,
103: content1_s3,
104: content1_s4,
105: content1_s5,
ad_marker:2m,
107: content2_s1,
108: content2_s2,
109: content2_s3,
110: content2_s4,
111: content2_s5,
]

7. Manifest window of 5 segments for 1080 profile:

[
content1_s1,
content1_s2,
content1_s3,
content1_s4,
content1_s5,
]

Existing user flow with the same example and user buffer.
1. “User 1” requests updated manifest from EPS
2. EPS finds the user buffer in its database. It pulls out the last published manifest state and the current user's buffer. Current user's buffer. Last published segment is s5.

User1: [
100: content1_s1,
101: content1_s2,
103: content1_s3,
104: content1_s4,
105: content1_s5,
ad_marker:2m,
107: content2_s1,
108: content2_s2,
109: content2_s3,
110: content2_s4,
111: content2_s5,
]

3. EPS service finds that the next segment is an ad-marker, it requests the replacement engine for ads. It passed 2 m as the ad break duration.
4. Replacement Decisioning Engine via Ad replacement engine gets the ads for this user. Let us assume, there was a 60 s worth of replacement with 2 ads. Ads returned [ad1:30 s, ad2:30 s]
5. Replacement Decisioning Engine gets the corresponding segments for these ads. Media Preparation response for these ads

```
    {
      ad1: {
        “Profile_1080”: [ad1_s1],
        “Profile_720”: [ad1_s1],
},
      ad2: {
        “Profile_1080”: [ad2_s1],
        “Profile_720”: [ad2_s1],
},
  }
```

6. EPS gets the above response and updates the user buffer like the following

User1: [
100: content1_s1,
101: content1_s2,
103: content1_s3,
104: content1_s4,
105: content1_s5,
106: ad1_s1,
106: ad2_s1,
107: content2_s1,
108: content2_s2,
109: content2_s3,
110: content2_s4,
111: content2_s5,
]

7. Manifest window of 5 segments for 1080 profile:

[
content1_s2,
content1_s3,
content1_s4,
content1_s5,
ad1_s1
]

### Example 2

Let us consider this as the live stream from a playout system

| | Media asset identifier | | | | | |
|---|---|---|---|---|---|---|
| | ad_{—} | | ad_{—} | | ad_{—} | |
| | slate | content | slate | content | slate | content |
| Duration | 120 s | 4 m 52 s | 120 s | 4 m 52 s | 120 s | 12 m 5 s |

With Elastic Playout ZeroSlate, this is going to be the final stream that will be seen by the same users

### User 1

| | Media asset identifier | | | | | | | | |
|---|---|---|---|---|---|---|---|---|---|
| | | | | | | | | | Ad & |
| | ad1 | ad2 | content | ad1 | ad2 | content | ad1 | content | promo |
| Duration | 30 s | 30 s | 4 m 52 s | 30 s | 30 s | 4 m 52 s | 60 s | 12 m 5 s | 180 s |

### User 2

| | Media asset identifier | | | | | | |
|---|---|---|---|---|---|---|---|
| | | | | | | | Ad & |
| | ad1 | content | content | ad1 | ad2 | content | promo |
| Duration | 30 s | 4 m | 4 m | 60 s | 60 s | 12 m | 180 s |
| | | 52 s | 52 s | | | 5 s | |

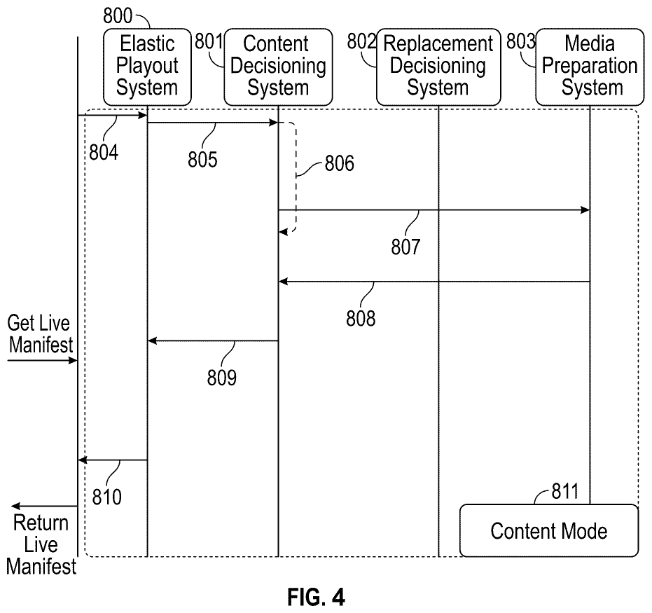

FIG. 4 discloses a computer-implemented method for zero-slate, within Free Ad-supported Streaming TV (FAST) for creating personalized linear channels with the ability to avoid slates/filler content during ad-breaks and manage viewer-specific ad loads with (a) a Media Preparation System 803, (b) a content decisioning system (CDS) 801, (c) an elastic playout system (EPS) 800, and (d) a replacement decisioning system (RDS) 802, capable of operating in (i) content mode and (ii) replacement mode. The method has the following steps—

In content mode 811, the user requesting EPS for a live manifest 804. EPS requesting CDS 805 for assets to play in the present time window. The CDS talking to a decisioning engine 806 to get the corresponding assets. The CDS getting one or more corresponding segments from the Media Preparation System 807. The Media Preparation System responding 808 with one or more transcoded segments for the request 807. The CDS responding 809 with segments to the EPS in response to 805. Finally, the EPS building a new playlist for the user request 804 and responding with the live manifest 810.

This figure also the overall method for the present invention including the creation of personalized ad breaks, means to shape ad breaks to cater to non-availability of ads for certain users, means to reset the live media stream to match the original EPG module, means for signal reset to reset streaming selectively for specific assets using in band SCTE signaling, means to declare a reset timeline as a configuration parameter where if the drift time exceeds a pre-configured duration then a reset is triggered. Means to declare a reset timeline as a configuration parameter where if the drift time exceeds a pre-configured duration, it triggers a reset. A drift timeline is maintained encapsulating the drift between a specific user and the corresponding original EPG timeline. The method can further autofill the drift duration with interesting content from the content owner's catalog.

This method works with four components, the Elastic Playout System (EPS) 800, the Content Decisioning System 801, the replacement decisioning system 802, and the media preparation system 803. Each component has a set of inputs and outputs.

The EPS 800 receives a live manifest for the channel. manifest for User requests the channel the manifest every X seconds as long as the their session is active 804. The EPS 800 also receives a Return array of replacement segments to stitch which matches the channel's transcoding spec 816 from the Replacement Decisioning Engine 802. The outputs of the EPS include a ‘Get live manifest for the channel’ 805, a ‘Get replacement content for this user and channel’ 812, a Return live stream HLS or DASH manifest for the user 810 and a Return live stream HLS or dash manifest for the user with replaced content 815.

The Content Decisioning System 801 has two inputs a Get live manifest for the channel 805 and a Return array of segments for the content assets matching the channel's transcoding profiles 808 and two outputs—a Get segments from the content assets matching the channel's transcoding profiles 807, a Return array of segments to stitch for channel's transcoding profiles including the replacement markers 809.

The Replacement Decisioning System 802 has two inputs a Get replacement content for this user and channel 812, a Return array of segments for the content assets matching the channel's transcoding profiles 817 and two outputs a Get segments from the ad assets matching the channel's transcoding profiles 814, a Return array of replacement segments to stitch which matches the channel's transcoding spec 816.

The Media Preparation System 803 has two inputs—a Get segments from the content assets matching the channel's transcoding profiles 807, a Get segments from the ad assets matching the channel's transcoding profiles 814 and two outputs—a Return array of segments for the content assets matching the channel's transcoding profiles 808, a Return array of segments for the content assets matching the channel's transcoding profiles 817.

We also disclose a non-transitory, machine-readable storage medium having stored there on a computer program for content decisioning using EPG within a zero-slate, within Free Ad-supported Streaming TV (FAST) for creating personalized linear channels with the ability to avoid slates/filler content during ad-breaks and manage viewer-specific ad loads, the computer program comprising a set of instructions for causing a machine to perform the steps of the method described in FIG. 9.

We also provide a legend below with reference numerals and descriptions, detailing the attributes in each exchange in many cases, for clarity, completeness and conciseness.

Legend with reference numerals and descriptions

| FIG. | Part | Description |
|---|---|---|
| 1 | 100 | Media & Metadata Store |
| | 101 | Auto Segmentation system |
| | 102 | EPG |
| | 103 | Recommendation Engine |
| | 104 | Delayed Live Stream |
| | 105 | Ad Servers |
| | 106 | Content Replacement |
| | 107 | Live Stream |
| | 108 | Media Preparation System |
| | 109 | Content Decisioning System |
| | 110 | Replacement Decisioning System |
| | 111 | Transcoder |
| | 112 | Elastic Playout System Convert array of media asset to a live |
| | | stream |
| | 113 | CDN |
| | 114 | Database |
| | 115 | Blob Store |
| | 116 | Database |
| | 117 | Blob Store |
| | 118 | Users ID |
| | 119 | Fetch manifest |
| | 120 | Fetch manifest from origin |
| | 121 | Get replacement content (Channel_ID, user's details) |
| | 122 | CMS |
| 2 | 200 | EPG |
| | 201 | Recommendation Engines |
| | 202 | Input Live Stream |
| | 203 | Media Preparation System |
| | 204 | Content Decisioning System |
| | 205 | EPG Ingest |
| | 206 | Recommendation Engines |
| | 207 | Input Live Stream |
| | 208 | Decisioning Engines |
| | 209 | Array of Media to Stitch for an User is Sent as Response. Ex: |
| | | Stream [Media1, Media2, Media3, . . . ] |
| | 210 | Checks if a Media is Already Transcoded. Else it Enqueues in |
| | | Transcoding Queue for Transcoding |
| | 211 | Get or Enqueue for- Transcoding Parameter: Channel, [Media . . . ] |
| | 212 | Get Program Content. Channel_ID, User's Details (IP, User Agent, |
| | | DeviceID, etc) |
| | 300 | Decisioning Engines |
| | | Media Preparation Service |
| 2a | 302 | Configuration Service |
| | 303 | Prepare Media |
| | 304 | Default Content |
| | 305 | Fetch Content |
| | 306 | Content Segment Server |
| | 307 | Load Balancer |
| 3 | 400 | Delayed Live Stream |
| | 401 | Ad replacement Engine |
| | 402 | Content replacement engine |
| | 403 | Media preparation system |
| | 404 | Content decisioning system |
| | 405 | Replacement decisioning |
| | 406 | Elastic playout system |
| | 407 | Live Streams |
| | 408 | Ad network (gam, pubmatic, etc) |
| | 409 | Get replacement content from configure or via an API |
| | 410 | VAST, VMAP Responses |
| | 411 | Decisioning engine. |
| | 412 | Return segments for a media if it is already transcoded. Média: |
| | | [media st, media_s2, media s3 for all the transcoding profiles of the |
| | | channel |
| | 413 | Replacement engines |
| | 414 | Array of media to stitch for an user is sent as response. Ex: stream |
| | | [media1, media2, media3, . . . ] |
| | 415 | Get or enqueue for transcoading params: Channel_ID, [media . . . ] |
| | 416 | Get program content. Channel_ID, user's details (ip, useragent, |
| | | deviceid, etc), device details |
| | 417 | Array of media to stitch for an user is sent as response. Ex: stream |
| | | [media1, media2, media3, . . . ] |
| | 418 | Checks if a media already transcoded. Else it enqueues in |
| | | transcoding queue for transcoding |
| | 419 | User's segment buffer user1: [media1 s1 media s2, media2 s1, |
| | | media2 s2 media3 s1, ad1 81, adt s2 media3 s2. Media3 s3, |
| | 420 | Get replacement content. Channel_ID, user's details (ip, useragent, |
| | | deviceid, etc), device details, EPG details, etc |
| | 421 | Manifest Fetch |
| | 422 | CDN |
| | 423 | Polls for manifest updates every x seconds for a channel user/player |
| | 424 | Array of replacement segments to stitch for an user is sent as |
| | | response ex stream [media1_s1, media1 s2 media2_s1, media2_s2 |
| | | media3 81, media3_s2, media3_s3 |
| | | EPG parsers |
| 3a | 501 | EPG STORE |
| | 502 | EPG Serving |
| | 503 | Customers Upload |
| | 504 | Get Content te Stitch for a Channel Starting from Time Fand for X |
| | | Seconds Duration |
| | 505 | Response [Media1, Media2, Media3, . . . ] |
| | 506 | Response |
| 5 | 800 | Elastic Playout system |
| | 801 | Content Decisioning System |
| | 802 | Replacement Decisioning System |
| | 803 | Media Preparation System |
| | 804 | Get live manifest |
| | 805 | Get live manifest for the channel |
| | | Fetch content form EPG, Recommendation pr Delayed live |
| | 807 | Get segments from the content assets matching the channel's |
| | | transcoding profiles |
| | 808 | Return live stream HLS or Dash manifest for the user |
| | 809 | Return array of segments to stich for channel's transcoding profiles |
| | | including the replacement markers |
| | 810 | Return array of segments for the content assets matching the |
| | | channel's transcoding profile |
| | 811 | Content mode |
| | 812 | Get replacement content for this user and channel |
| | 813 | Fetch Replacement content from ad-servers |
| | 814 | Get segments from the ad assets matching the channel's |
| | | transcoding profiles |
| | 815 | Return live stream HLS or Dash manifest for the user with replaced |
| | | content |
| | 816 | Return array of replacement segments to stich which matches the |
| | | channel's transcoding spec |
| | 817 | Return array of segments for the content assets matching the |
| | | channel's transcoding profiles |
| | 818 | Replacement mode |

What is claimed is:

1. A system for Content Decisioning within a Zero-Slate system for Linear TV with Elastic Playout interfacing with an EPG Service comprising: (a) an Electronic Programming Guide (EPG) Service 400, (b) one or more replacement engines 413, (c) a media preparation system 403, (d) a content decisioning system 404, (e) a replacement decisioning system 405, (f) an elastic playout system 406 and (g) a content distribution network (CDN) 425 wherein:
a) an EPG Service 400 ingests one or more EPGs 407, consumes the EPG schedules that are uploaded by the customer and stores it into a timestamp to asset mapping and also takes as input an array 414 of media to stitch for a user is sent as response;
b) the replacement engines 413 comprises of an ad replacement engine 401 and a content replacement engine 402;
c) the media preparation engine 403 interacts with the replacement decisioning engine 405 by obtaining one or more return segments for a media if it is already transcoded media: [media_s1, media_s2, media_s3], for all the transcoding profiles of the channel 412. 403 further interacts with the content decisioning system 404 by obtaining for transcoding parameters 416;
d) the content decisioning engine 404 exchanges an array of segments to stitch for a user 419 from the Elastic Playout System (EPS) 406 including program content 418;
e) the EPS 406 further exchanges replacement content 421 and an Array of replacement segments 422 and interacts with a User's segment buffer 420; and
f) the content distribution network (CDN) 425 interacts with the EPS which polls for manifest updates 424 and the EPS 406 and performs a manifest fetch for a user 423.

2. The system of claim 1 wherein the EPG service further comprises:
a) one or more customers 503 uploading EPG in multiple formats;
b) one or more EPG parsers 500 bringing them into a unified format and with an EPG store 501 that enables every channel to get a twenty four hour playlist 504 daily; and
c) there is also an EPG serving subsystem 502 that returns an array of media 506.

3. The system of claim 2 wherein the input to the EPG serving subsystem is customers uploading their customer or standard representations of the EPG and the content to stitch for a channel starting from time ‘T’ and for a duration of ‘x’ seconds 505, where ‘x’ can vary to create a personalized stream for every user.

4. The system of claim 1 wherein the EPG service 400 uses the wall clock time that is sent as input to return the array of assets to play starting from the wall clock time when the content decisioning engine asks for the content to play.

5. The system of claim 1 wherein a user can be (a) a new user, (b) an existing user or (c) an existing user with ad replacements.

6. The system of claim 1 wherein a new user undertakes the steps of:
a) User requesting for a live manifest of a channel, this request interacting with the CDN and the EPS;
b) the Elastic Playout System checking its database if a segment buffer exists for this user and actioning the content decisioning system if none is found;
c) the Content decisioning engine checking the configured decision engine for the user's Channel_ID for the current time ‘T’ and calling the corresponding decision engine in conjunction with the EPG service;
d) the EPG service checking the assets that is scheduled to be played at time T that is passed as input and returning subsequent T+X min worth of extra assets to play for the user;
e) the Content decisioning engine getting an array of assets to play from the EPG service and then calling the Media Preparation Service for the segments for these assets;
f) the Media Preparation Service checking its database if the assets are already transcoded and if so, returning the segments for all the transcoding profiles that are configured for this channel alongside the ad break points for the assets;
g) the Content decisioning getting the corresponding segments for the assets that are supposed to be played for a user;
h) for the assets which are not transcoded yet, the content decisioning sending out alternate content to play, these alternate content to play are configured at the channel level;
i) the Elastic Playout System getting the array of segments to stitch and the ad breakpoints for all the assets, building a segment buffer for the user and then building the manifest for this user and responds it back to the user via the CDN; and
j) the Elastic Playout System keeping track of the liveliness of the user and flushing the segment buffer of unresponsive users.

7. The system of claim 1 wherein an existing user undertakes the steps of:
a) the user requesting a live manifest of a channel, this request reaching the CDN which in turn calls the origin Elastic Playout System;
b) the Elastic Playout System checking its database if a segment buffer exists for this user and upon finding it moving the manifest window by a segment and updates the user state; and
c) the EPS then building the updated manifest and responds it back to the user.

8. The system of claim 1 wherein an existing user with ad replacements undertakes the steps of:
a) the user requesting a live manifest of a channel, this request reaching the CDN which in turn calls the origin EPS;
b) the EPS checking in its database if a segment buffer exists for this user and upon finding the segment buffer, checking if the next segment to publish to the user has a trigger marker and if so, sending a request to the Replacement Decisioning Engine;
c) the Replacement Decisioning Engine using the trigger marker to determine the replacement engine type and calling the ad replacement engine;
d) the Ad replacement Engine using the channel information to get the ad- tag and replacing the macros in the ad-tag with user details and requests ad-servers;
e) the or more AdServers responding with the VAST or VMAP XML parsed by the ad replacement engine and the ad assets in the XML, ad trackers are captured and subsequently building an internal standardized response to send out;
f) Replacement Decisioning Engine getting the ad assets and the trackers from ad replacement engine and then getting the corresponding ad assets segments from media preparation system;
g) skipping the stitching step when an ad is not transcoded yet in media preparation system but enqueued for transcoding so that it becomes usable in future;
h) the Replacement Decisioning Engine responding to the EPS; and
i) the Elastic Playout System appending the ads to the user's segment buffer, stitching these ads in the manifest, adding beacons in the manifest so that the ad quartiles can be tracked and reported back to ad-servers.

9. The system of claim 1 wherein extending the user's segment buffer comprises:
a) the user requesting a live manifest of a channel, this request reaching the CDN which in turn calls the origin-Elastic Playout System (EPS);
b) the Elastic Playout System first checks in it database if a segment buffer exists for this user and when it finds the segment buffer of that user, it checks if the buffer is about to be exhausted, at which point fresh requests are made to Content Decisioning System passing the last segment's timestamp;
c) the Content Decisioning System then gets the content segments to play starting from this timestamp and returns the content assets after which the user is treated similar to a new user; and
d) these segments are appended to the user's segments buffer and the playout continues to happen.

10. The system of claim 1 wherein the ad replacement engine 401 further:
a) obtains an Array of media to stitch for a user 415 from the replacement decisioning system 405;
b) requests ad servers for personalized ads for a user; and
c) passes user details, device details, EPG details, etc. to them to get personalized ads interacts with one or more ad networks 408 via VAST/VMAP responses 409.

11. The system of claim 1 wherein the content replacement engine 402 further:
a) picks pre-defined content based on the channel's config or calls an API to get the replacement content;
b) standardizes the response and sends it back; and
c) gets replacement content from configured values or via an API 410.

12. The system of claim 1 wherein the media preparation engine 403 interacts with the replacement decisioning engine by obtaining one or more return segments for a media if it is already transcoded media 416.

13. The system of claim 1 wherein the ad networks exemplarily include GAM and PubMatic.

14. A computer-implemented method for content decisioning with EPG for zero-slate, within Free Ad-supported Streaming TV (FAST) for creating personalized linear channels with the ability to avoid slates/filler content during ad-breaks and manage viewer-specific ad loads with (a) a Media Preparation System 803, (b) a content decisioning system (CDS) 801, (c) an elastic playout system (EPS) 800, and (d) a replacement decisioning system (RDS) 802, capable of operating in content mode the steps of:
a) User requesting EPS for a live manifest 804;
b) EPS requesting CDS 805 for assets to play in the present time window;
c) the CDS talking to a decisioning engine 806 to get the corresponding assets;
d) the CDS getting one or more corresponding segments from the Media Preparation System 807;
e) the Media Preparation System responding 808 with one or more transcoded segments for the request 807;
f) the CDS responding 809 with segments to the EPS in response to 805; and
g) the EPS building a new playlist for the user request 804 and responding with the live manifest 810.

15. The computer-implemented method of claim 14 wherein the CDS talks to a decisioning engine 806 which is an EPG.

16. The computer-implemented method of claim 14 wherein the RDS talks to the EPS 813 where:
a) a replacement engine returns one or more ad assets; or
b) a replace engine returns one or more replacement content segments; or
c) a replacement engine returns one or more live segments.

17. The computer-implemented method of claim 14 wherein the assets in b include Channel_ID, user details, device details, EPG details, and trigger-type as inputs.

18. The computer-implemented method of claim 14 wherein the Ad server (a) has interactions exemplarily handled by ad-servers service, (b) the response expected from ad-servers is either VAST or VMAP.

19. The computer-implemented method of claim 14 wherein the EPS 800 further:
a) receives a live manifest for the channel. manifest for User requests the channel the manifest every ‘X’ seconds as long as the their session is active 804;
b) receives a Return array of replacement segments to stitch which matches the channel's transcoding spec 816 from the Replacement Decisioning Engine 802; and
c) sends a ‘Get live manifest for the channel’ 805, a ‘Get replacement content for this user and channel’ 812, a ‘Return live stream HLS or DASH manifest’ for the user 810 and a ‘Return live stream HLS or dash manifest for the user with replaced content’ 815.

20. The computer-implemented method of claim 14 wherein the Content Decisioning System 801 further:
a) receives a live manifest for the channel 805 and a Return array of segments for the content assets matching the channel's transcoding profiles 808; and
b) sends ‘a Get segments from the content assets matching the channel's transcoding profiles’ 807 and a ‘Return array of segments to stitch for channel's transcoding profiles including the replacement markers’ 809.

21. The computer-implemented method of claim 14 wherein the Replacement Decisioning System 802 further:
a) receives a ‘Get replacement content for this user and channel’ 812 and ‘a Return array of segments for the content assets matching the channel's transcoding profiles; 817; and
b) sends a ‘Get segments from the ad assets matching the channel's transcoding profiles’ 814, and ‘a Return array of replacement segments to stitch which matches the channel's transcoding spec’ 816.

22. The computer-implemented method of claim 14 wherein the Media Preparation System 803 further:
a) receives ‘a Get segments from the content assets matching the channel's transcoding profiles’ 807, and a ‘Get segments from the ad assets matching the channel's transcoding profiles’ 814; and
b) sends a Return array of segments for the content assets matching the channel's transcoding profiles 808 and a Return array of segments for the content assets matching the channel's transcoding profiles 817.

23. A non-transitory, machine-readable storage medium having stored there on a computer program for content decisioning with EPG zero-slate, within Free Ad-supported Streaming TV (FAST) for creating personalized linear channels with the ability to avoid slates/filler content during ad-breaks and manage viewer-specific ad loads with (a) a Media Preparation System 803, (b) a content decisioning system (CDS) 801, (c) an elastic playout system (EPS) 800, and (d) a replacement decisioning system (RDS) 802, capable of operating in content mode the computer program comprising a set of instructions for causing a machine to perform the steps of:
a) User requesting EPS for a live manifest 804;
b) EPS requesting CDS 805 for assets to play in the present time window;
c) the CDS talking to a decisioning engine 806 to get the corresponding assets;
d) the CDS getting one or more corresponding segments from the Media Preparation System 807;
e) the Media Preparation System responding 808 with one or more transcoded segments for the request 807;
f) the CDS responding 809 with segments to the EPS in response to 805; and
g) the EPS building a new playlist for the user request 804 and responding with the live manifest 810.
